(19) United States
(12) Patent Application Publication
(10) Pub. No.: US 2012/0216502 A1
(43) Pub. Date: Aug. 30, 2012

(54) GAS TURBINE INTERCOOLER WITH TRI-LATERAL FLASH CYCLE

(75) Inventors: Sebastian Walter Freund, Unterfohring (DE); Pierre Sebastien Huck, Munich (DE); Thomas Johannes Frey, Regensburg (DE)

(73) Assignee: GENERAL ELECTRIC COMPANY, Schenectady, NY (US)

(21) Appl. No.: 13/035,206

(22) Filed: Feb. 25, 2011

(51) Int. Cl. F02C 1/05

(52) U.S. Cl. 60/39.17

(57) ABSTRACT

A gas turbine intercooler operates to heat a predetermined organic fluid via heat generated by the gas turbine. The heated organic fluid remains in a partially evaporated or non-evaporated liquid phase to provide a heated organic fluid that reaches a state of saturation with a vapor quality less than unity. An expansion machine expands the heated organic fluid via a Tri-Lateral Flash cycle to increase the vapor quality and generate electrical power therefrom.

### BACKGROUND

This invention relates generally to gas turbine engines, and more particularly, to a system and method for extracting and using heat from a gas turbine's intercooler in a specific organic Rankine cycle called Tri-Lateral Flash cycle.

Gas turbine engines generally include, in serial flow arrangement, a high-pressure compressor for compressing air flowing through the engine, a combustor in which fuel is mixed with the compressed air and ignited to form a high temperature gas stream, and a high-pressure turbine. The high-pressure compressor, combustor and high-pressure turbine are sometime collectively referred to as the core engine. At least some known gas turbine engines also include a low-pressure compressor, or booster, for supplying compressed air to the high-pressure compressor.

Gas turbine engines are used in many applications, including aircraft, power generation, and marine applications. The desired engine operating characteristics vary, of course, from application to application. Gas turbines alone have a limited efficiency and a significant amount of useful energy is wasted as hot exhaust gas that is discharged to the ambient.

An intercooler facilitates increasing the efficiency of the engine; however, the heat rejected by the intercooler is not utilized by the gas turbine engine, and the intercooler heat from an intercooled gas turbine or compressor is usually wasted. In some applications, a cooling tower discharges intercooler heat to the ambient at a low temperature level. Discharging the heat at low temperature requires rather large heat exchangers and fans. However, since this is low-grade heat, available only at temperatures below that of the compressor discharge air, using this heat in an efficient way to generate electricity is challenging.

The heat from inter-cooling a gas turbine compressor can be utilized for power generation with an Organic Rankine Cycle (ORC). A suitable ORC for an intercooler not only has to generate power, but moreover has to provide as much cooling as possible since the primary purpose of an intercooler is to lower the air temperature. A conventional ORC (similar to a steam cycle) has a disadvantage for this application, since a large fraction of the heat is extracted at the boiling temperature, leading to a pinch-point problem that limits the amount of heat and the exit air temperature.

In view of the foregoing, there is a need for a system and method for extracting and using heat from a gas turbine's intercooler for use in generating power, thus further increasing the system efficiency while decreasing the parasitic load of the cooling system.

### BRIEF DESCRIPTION

According to one embodiment, a Tri-Lateral Flash cycle turbine power plant comprises:

a gas turbine;

a gas turbine intercooler configured to heat a predetermined organic fluid via heat generated by a corresponding gas turbine compressor, wherein the heated organic fluid remains in a partially evaporated or non-evaporated liquid phase to provide a heated organic fluid that reaches a state of saturation with a vapor quality less than unity; and

an expansion machine configured to expand the heated organic fluid via a Tri-Lateral Flash cycle to increase the vapor quality and generate electrical power therefrom.

According to another embodiment, a Tri-Lateral Flash cycle intercooled gas turbine power plant comprises:

a gas turbine;

a gas turbine intercooler configured to heat a predetermined organic fluid towards saturation via heat generated by a corresponding gas turbine compressor and to generate a boiling fluid therefrom; and

a turbo expander configured to expand the boiling organic fluid via a Tri-Lateral Flash cycle to generate electrical power therefrom.

According to yet another embodiment, a method of generating power via a Tri-Lateral Flash cycle turbine power plant comprises:

heating a predetermined organic fluid towards saturation via a gas turbine intercooler and generating a boiling fluid therefrom; and

expanding and superheating the boiling organic fluid via an expander during a wet expansion Tri-Lateral Flash cycle to generate electrical power therefrom.

### DRAWINGS

These and other features, aspects, and advantages of the present invention will become better understood when the following detailed description is read with reference to the accompanying drawing, wherein:

FIG. 1 is a simplified schematic diagram illustrating a gas turbine including an intercooler configured to heat an ORC fluid according to one embodiment;

FIG. 2 is a simplified system diagram illustrating a Tri-Lateral Flash cycle turbine power plant according to one embodiment; and

FIG. 3 is a graph illustrating cooling curves for both air and an organic fluid in response to a Tri-Lateral Flash cycle that results in closely matched cooling curves.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

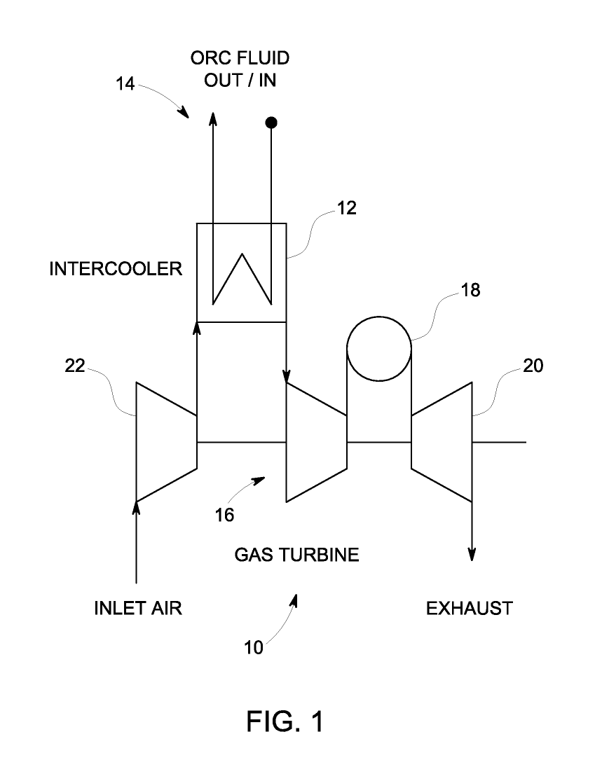

FIG. 1 is a simplified schematic diagram illustrating a gas turbine 10 including an intercooler 12 configured to heat an ORC fluid 14 according to one embodiment. Gas turbine engine 10 includes, in serial flow arrangement, a compressor 16 for compressing air flowing through the engine, a combustor 18 in which fuel is mixed with the compressed air and ignited to form a high temperature gas stream, and a high-pressure turbine 20. The compressor 16, combustor 18 and turbine 20 are sometime collectively referred to as the core engine. At least some known gas turbine engines also include a low-pressure compressor 22, or booster, for supplying compressed air to a high-pressure compressor 16.

Gas turbine engines are used in many applications, including aircraft, power generation, and marine applications, as stated herein. The desired engine operating characteristics vary, of course, from application to application. Gas turbines alone have a limited efficiency and a significant amount of useful energy is wasted as hot exhaust gas that is discharged to the ambient.

An intercooler 12 facilitates increasing the efficiency of the engine; however, the heat rejected by the intercooler 12 is not utilized by the gas turbine engine 10, and the intercooler heat from an intercooled gas turbine or compressor is usually wasted as stated herein. In some applications, a cooling tower discharges intercooler heat to the ambient at a low temperature level. Discharging the heat at low temperature requires rather large heat exchangers and fans. However, since this is low-grade heat, available only at temperatures below that of the compressor discharge air, using this heat in an efficient way to generate electricity is challenging.

The heat from inter-cooling a gas turbine compressor can be utilized for power generation with an Organic Rankine Cycle (ORC), as stated herein. A suitable ORC for an intercooler not only has to generate power, but moreover has to provide as much cooling as possible since the primary purpose of an intercooler is to lower the air temperature. A conventional ORC (similar to a steam cycle) has a disadvantage for this application, since a large fraction of the heat is extracted at the boiling temperature, leading to a pinch-point problem that limits the amount of heat and the exit air temperature.

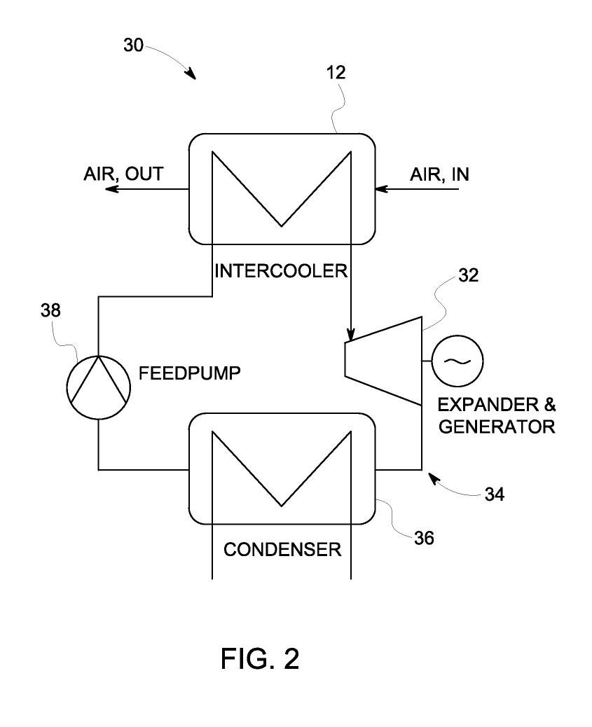

FIG. 2 is a simplified system diagram illustrating a Tri-Lateral Flash cycle turbine power plant 30 according to one embodiment. Tri-Lateral flash cycle turbine power plant 30 extracts and uses heat from a gas turbine's intercooler 12 for use in generating power, thus further increasing the system efficiency while decreasing the parasitic load of the cooling system. More specifically, the power plant 30 uses intercooler 12 heat to heat an organic fluid in its liquid phase without evaporation such that the corresponding non-evaporated air cooling curve(s) substantially match the organic fluid heating curve(s). In this way, the maximum amount of heat in the fluid vapor line can be extracted from the non-evaporated fluid air heat in similar fashion to the heat transfer achieved in a water-cooled intercooler or air-cooled intercooler.

More specifically, the organic fluid reaches a state of saturation with very low vapor quality. The heated organic fluid is expanded in a suitable expansion machine 32 using a wet expansion process having a vapor quality less than unity. This expansion process is known to those skilled in the art as Tri-Lateral Flash, and so further details regarding Tri-Lateral Flash expansion will not be described in further detail herein to preserve brevity and enhance clarity with respect to understanding the gas turbine intercooler with Tri-Lateral Flash cycle principles described herein.

The vapor quality described above increases during the expansion process when using a typical ORC working fluid such as, for example, i-Pentane or n-Butane. The post expansion fluid 34 is substantially fully condensed via a suitable condenser 36 and is then pumped to a higher pressure to be heated again via the intercooler 12, completing the thermal cycle. Thermodynamic calculations have demonstrated that the foregoing cycle can meet the cooling demand while generating power at reasonable efficiency levels according to particular embodiments. An intercooler package equipped with this cycle would, for example, turn a parasitic load of pumps and fans and water consumption into a water-free device producing additional power.

In summary explanation, a gas turbine intercooler 12 is used to heat a suitable organic fluid towards saturation by cooling the hot gas turbine air in a suitable heat exchanger. The saturated organic fluid is subsequently expanded in a turbo-expander 32 to generate power. The heated organic fluid in this process is not or only partially evaporated in the heat exchanger 14, and therefore enters the expander 32 as a boiling liquid. Due to the positive slope of the vapor line associated with the temperature-saturation characteristics of suitable organic fluids, the expansion process using a Tri-Lateral Flash cycle leads to further evaporation and ends at a superheated state. The fluidic vapor subsequent to the expansion is brought to a condenser 36 and to a feed pump 38 to close the cycle.

A suitable heat exchanger configuration according to one embodiment comprises a serpentine coil tube with large, tightly spaced and enhanced continuous plate fins, enclosed in a pressure shell. Hot air and fluid may flow in a counterflow direction, with the fluid tubes arranged in multiple parallel passes. According to another embodiment, as an alternative to heating the organic fluid directly in the intercooler 12, an intermediate loop with an additional heat exchanger for the fluid may be employed to separate the organic fluid from the air. This embodiment safeguards against leakage to increase safety, and may employ a more inert heat transfer fluid such as water or thermal oil.

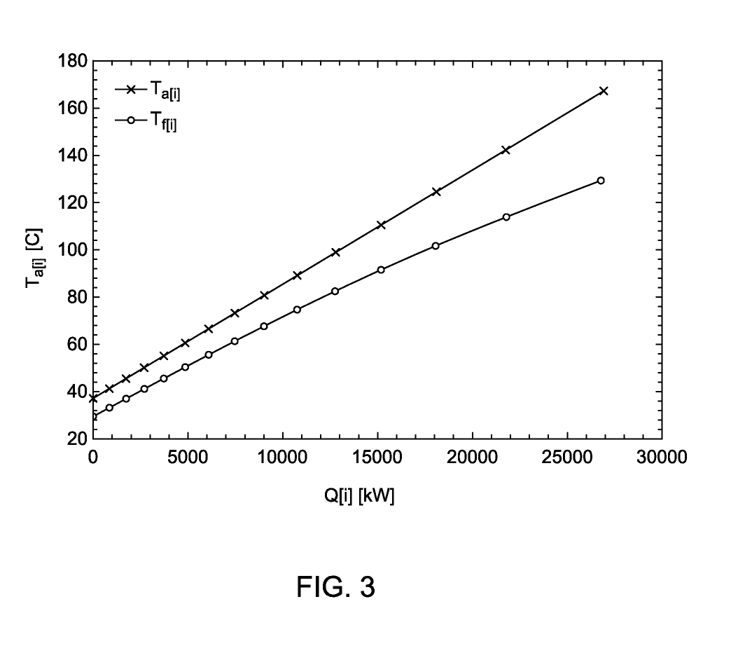

The gas turbine intercooler with Tri-Lateral Flash cycle principles described herein advantageously increases the efficiency of the plant by about 3% for one embodiment in contrast to a typical ORC or steam cycle, in which the fluid is preheated, evaporated and superheated before expansion. The Tri-Lateral Flash cycle allows a smooth heating curve of the fluid without phase change. No pinch point occurs since no heat is added at constant temperature such as during boiling. This feature enables matching heating and cooling curves and results in more efficient cooling of air. FIG. 3 that is a graph illustrating a cooling curve for air and the heating curve of an organic fluid associated with an intercooler that results in closely matched cooling/heating curves according to one embodiment.

The foregoing increased efficiency is achieved at a low incremental cost since the typical cooling system is replaced by an ORC system. Because no additional fuel is required, the power advantageously increases about as much as the efficiency by the amount of the net power output from the ORC system.

The embodiments described herein can thus be seen to employ intercooler heat from a gas turbine in a Tri-Lateral Flash cycle to produce electricity. It should be noted that only the intercooler heat is used as a heat source in accordance with the principles described herein to produce electricity through a thermodynamic cycle; and other heat sources are not employed or required to achieve the desired results.

While the invention has been described in terms of various specific embodiments, those skilled in the art will recognize that the invention can be practiced with modification within the spirit and scope of the claims.

What is claimed is:

1. A Tri-Lateral Flash cycle turbine power plant comprising:
a gas turbine;
a gas turbine intercooler configured to heat a predetermined organic fluid via heat generated by a corresponding gas turbine compressor, wherein the heated organic fluid remains in a partially evaporated or non-evaporated liquid phase to provide a heated organic fluid that reaches a state of saturation with a vapor quality less than unity; and
an expansion machine configured to expand the heated organic fluid via a Tri-Lateral Flash cycle to increase the vapor quality, decrease the pressure and generate electrical power therefrom.

2. The power plant according to claim 1, wherein the organic fluid is selected from hydrocarbons and refrigerants.

3. The power plant according to claim 2, wherein the hydrocarbons and refrigerants are selected from i-Pentane and n-Butane.

4. The power plant according to claim 1, wherein the expansion machine comprises a wet expansion machine.

5. The power plant according to claim 1, wherein the organic working fluid substantially matches the thermal capacitance rate of the compressed air in a way that allows cooling the air to a desired outlet temperature while heating the fluid to a desired saturated outlet state.

6. The power plant according to claim 1, wherein the gas turbine intercooler is the sole heat source associated with the power plant.

7. The power plant according to claim 1, further comprising:
a condenser configured to condense the expanded organic fluid; and
a pump configured to pump the condensed fluid under high pressure back to the intercooler.

8. The power plant according to claim 1, further comprising an intermediate heat transfer fluid loop including a heat exchanger for heating the organic fluid, wherein the intermediate heat transfer fluid is heated by the compressed air in the gas turbine intercooler without the organic fluid being heated directly by the intercooler.

9. A Tri-Lateral Flash cycle turbine power plant comprising:
a gas turbine;
a gas turbine intercooler configured to heat a predetermined organic fluid towards saturation via heat generated by a corresponding gas turbine compressor and to generate a boiling fluid therefrom; and
a turbo expander configured to expand the boiling organic fluid via a Tri-Lateral Flash cycle to generate electrical power therefrom.

10. The power plant according to claim 9, wherein the organic fluid is selected from hydrocarbons and refrigerants.

11. The power plant according to claim 9, wherein the boiling fluid comprises a liquid portion and a gaseous air portion, such that the cooling characteristics of the air portion substantially match the heating characteristics of the liquid portion for predetermined temperature and saturation limits.

12. The power plant according to claim 9, wherein the gas turbine intercooler is the sole heat source associated with the power plant.

13. The power plant according to claim 9, further comprising:
a condenser configured to condense the expanded organic fluid; and
a pump configured to pump the condensed fluid under high pressure back to the intercooler.

14. The power plant according to claim 9, further comprising an intermediate heat transfer fluid loop including a heat exchanger for heating the organic fluid, wherein the intermediate heat transfer fluid is heated by the compressed air in the gas turbine intercooler without the organic fluid being heated directly by the intercooler and without the organic fluid passing through the intercooler.

15. A method of generating power via a Tri-Lateral Flash cycle turbine power plant, the method comprising:
heating a predetermined organic fluid towards saturation via a gas turbine intercooler and generating a boiling fluid therefrom; and
expanding and superheating the boiling organic fluid via an expander during a wet expansion Tri-Lateral Flash cycle to generate electrical power therefrom.

16. The method according to claim 15, wherein the organic working fluid substantially matches the thermal capacitance rate of a compressed air in a way that allows cooling the air to a desired outlet temperature while heating the fluid to a desired saturated outlet state.

18. The method according to claim 15, wherein the gas turbine intercooler is the sole heat source associated with the power plant.

19. The method according to claim 15, further comprising:
condensing the expanded organic fluid via a condenser; and
pumping the condensed fluid under high pressure back to the intercooler via a high-pressure feed pump.

20. The method according to claim 15, wherein heating a predetermined organic fluid towards saturation via a gas turbine intercooler further comprises:
providing an intermediate heat transfer fluid loop including a heat exchanger for heating the organic fluid; and
heating the heat transfer fluid with compressed air passing through the intercooler.
